(19) United States
(12) Patent Application Publication
(10) Pub. No.: US 2014/0159364 A1
(43) Pub. Date: Jun. 12, 2014

(54) COGENERATION SYSTEM WITH OIL AND FILTER CHANGE FEATURE

(71) Applicants: Kenneth P. Harris, Deerfield, IL (US); Brian C. Skinner, Buchanan, MI (US)

(72) Inventors: Kenneth P. Harris, Deerfield, IL (US); Brian C. Skinner, Buchanan, MI (US)

(21) Appl. No.: 13/989,669

(22) PCT Filed: Aug. 1, 2012
(86) PCT No.: PCT/US12/49200

§ 371 Date: May 24, 2013

Related U.S. Application Data
(60) Provisional application No. 61/524,373, filed on Aug. 17, 2011.

(51) Int. Cl. F01M 11/03; F02G 5/02; H02K 7/18

(52) U.S. Cl. CPC F01M 11/03; H02K 7/1815; F02G 5/02
USPC 290/2

(57) ABSTRACT

A cogeneration machine with an oil and filter change feature is disclosed. The present invention makes it possible to change the oil and/or the oil filters of a reciprocating engine in cogeneration equipment without turning off the engine. A cogeneration system user can safely change the engine oil or oil filters in the system without effecting its operation or incurring the significant costs associated with taking the system off-line.

### CROSS REFERENCE TO RELATED APPLICATIONS

The present application claims the benefit of priority of International Patent Application No. PCT/US2012/049200, filed on Aug. 1, 2012, which in turn claims the benefit of provisional U.S. Patent Application Ser. No. 61/524,373 filed on Aug. 17, 2011. The entire text of International Patent Application No. PCT/US2012/049200 and provisional U.S. Patent Application Ser. No. 61/524,373 are hereby incorporated herein by reference in their entireties.

### BACKGROUND OF THE INVENTION

Most of the electricity generated in the world is produced from the consumption of fossil fuels (coal, natural gas, oil, etc.). During the process, two types of energy are generated—approximately ⅓ of the energy generated is in the form of electricity and ⅔ is in the form of heat. Generally, the heat generated by the process is considered a by-product and is exhausted into the atmosphere as waste. Cogeneration is the term describing the process of generating electricity and recycling the heat associated with that generation for other uses. A well known example of this process is in New York City where the utilities use the waste heat from electrical generation to provide community steam heat to buildings in Manhattan. The effective utilization of the heat that would normally be exhausted into the atmosphere can result in energy generation efficiency gains of more than 100%. Additionally, nearly 10% of the electrical energy generated is lost during transmission over the traditional electric grid. The generation efficiencies can lead to meaningful costs savings and significantly reduce the use of fossil fuels as well as lowering the overall environmental impact associated with energy production and use.

Currently, cogeneration equipment provides nearly 10% of the electrical generation capacity in the United States, with concentrations in some areas reaching 20% or more of total capacity. Cogeneration equipment can be utilized in large and small applications. Most systems run in parallel and conjunction with the utility electric grid to provide a particular site with a significant portion of its energy needs. The U.S. Department of Energy has specifically identified cogeneration as one of the single most effective ways to reduce the environmental impact of electrical generation and actively promotes the adoption of this technology. According to a U.S. Department of Energy database, cogeneration systems have been installed in the U.S. ranging in capacity from as large as 1.5 Gigawatts to as small as 10 Kilowatts.

In non-residential applications, electricity is billed in two significant portions: kilowatt-hour usage and demand charges. Kilowatt-hour charges are calculated by measuring the total amount of electricity used by the customer in a billing period. Demand charges are calculated by measuring the peak usage over a short period of time, usually 15 minutes, during the month. By way of example, two customers could use the same amount of electricity in any given month, but if one customer uses a relatively level amount of electricity each day and another takes their energy in short, high energy periods, the latter will pay significantly more for energy than the former.

Cogeneration units provide operational savings in 3 main areas: electrical generation efficiencies, using recycled heat energy, and reducing the costs associated with “peak demand charges.” Peak demand charge reduction refers to the demand charges being reduced by providing a base load of electricity. This supply of on-site generated electricity reduces the user's utilization of the traditional electric infrastructure, thereby providing a 1 for 1 reduction of peak usage. Depending on the application, each of the above areas can produce significant savings to a cogeneration system user. However, peak demand charges are the most important factor in maintaining operational uptime because even a very short period of non-operation can cause the customer to lose all of the potential demand savings for the monthly billing period. In addition to the functions described above, the CHP system can be used as a back-up generator when the site loses power from the local utility. This feature creates an additional benefit for cogeneration users by providing them with protection against power outages and the costs associated with these events.

Cogeneration systems are designed to run continuously to provide a constant energy supply 24 hours a day and 7 days a week. The systems are powered by many types of equipment including boilers, turbines and reciprocating internal combustion engines powered by various fuels (diesel fuel, gasoline, natural gas, etc.). Reciprocating engines are typically utilized in smaller systems. In the U.S., the median capacity of systems utilizing reciprocating engines is 225 kW. Reciprocating engine-driven cogeneration systems account for approximately 50% of all cogeneration systems installed in the country and 75% of all systems under 500 kW.

While less expensive than other types of engines in many ways, reciprocating engines require more frequent maintenance and must be turned off during simple service operations. The main driver for this frequency of service is the need to keep the oil clean, which is accomplished by changing the oil and oil filters on a regular basis. The typical frequency of oil changes is 30 to 60 days. Cogeneration users experience high costs when a unit is turned off for service. These costs include: the direct costs associated with a service call, the forfeited savings from the loss of on-site generation of electricity and the associated loss of heat recycling while the system is not in operation. In addition, when the equipment is turned off for as little as 15 minutes, the savings associated with peak demand reductions are forfeited for the billing period. In total, the combined costs and revenue losses associated with a service outage can be substantial, but the demand savings forfeiture associated with a short duration system outage alone can be as high as 25% or more of the total monthly electric bill.

Thus, it is highly desirable to reduce the significant costs associated with turning a cogeneration unit off during an oil service.

A product called OIL MATE™, manufactured by Engineered Machined Products, Inc., is described on its webpage as “an advanced oil management system for diesel engines that significantly extends oil change intervals and filter life in order to decrease down time and lengthen an engines life span.” The content of said webpage is incorporated by reference into this patent application as is fully set forth herein.

A product called REVOLUTION™ Centrifuge Systems has a webpage that discloses a centrifuge for use in internal combustion engines. The REVOLUTION™ Centrifuge is described on its webpage as a centrifuge system whose purpose is to reduce the amount of abrasive particles in an engine's oil. The content of said webpage is incorporated by reference into this patent application as is fully ser forth herein.

The product called LM500 Lube Level Maintainer by MURPHY® is an example of an oil replenishing system. Said product is distributed by MurCal, Inc. According to MurCal, Inc's., webpage the LM500 maintains oil level on any size engine. The content of said webpage is incorporated by reference into this application as if fully set forth herein.

U.S. Pat. Nos. 5,390,762, 5,720,249, 5,554,278, and U.S. patent application Ser. No. 12/359,768 are directed to devices that remove small amounts of used oil from a crankcase, inject such oil into an engine powered by a liquid fuel source to be burned and replace the removed oil with new oil. All of this patents and the application are incorporated by reference into this patent application as is fully ser forth herein.

U.S. Pat. No. 5,904,841 is directed to a device that an operator may attach to an engine using pre-fitted connections. The device includes an auxiliary powered centrifuge and industrial filters/separators to hyper-clean oil used in the engine. The entire content of this patent is also incorporated herein by reference.

U.S. Pat. No. 7,686,136 is directed to changing oil in an engine by transferring oil between the engine and alternate tanks using auxiliary or supplemental pumps. The entire content of this patent is also incorporated herein by reference.

The entire contents of U.S. Pat. Nos. 5,390,217 and 5,637,217 are incorporated by reference as if fully set forth herein.

### BRIEF SUMMARY OF THE INVENTION

In its broadest sense, the present invention makes it possible to change the oil and/or the oil filters of a reciprocating engine in cogeneration equipment without turning off the engine. By utilizing the present invention, a cogeneration system user can safely change the oil or oil filters in their system without effecting the operation or incurring the significant costs associated with taking the system off-line.

### BRIEF DESCRIPTION OF THE DRAWINGS

Various examples, objects, features and attendant advantages of the present invention become better understood when considered in conjunction with the accompanying drawings. Several views of the same or similar parts are shown. The figures are as follows:

FIG. 1 shows a typical reciprocating engine driven CHP cogeneration system incorporating an embodiment of the present invention;

FIG. 2 shows the oil system configuration of the engine 12 shown in FIG. 1 that will allow for the changing of oil without the necessity of turning the engine off during servicing;

FIG. 3 shows the revised oil system configuration with the addition of multiple oil filters that can be individually isolated and changed without effecting the operation of the engine;

FIG. 4 shows an alternate embodiment of the present invention for engine 12 with the addition of an oil pressure accumulator that can minimize oil pressure variations associated with inconsistent valve operation;

FIG. 5 shows an alternate construction for the FIG. 4 embodiment with the addition of electronically actuated valves which allows for automation and consistent application of the oil changing process;

FIG. 6 shows a further alternative embodiment of the present invention with a single point of connection to facilitate automated oil changes and faster manual oil evacuation/replenishing while reducing the risk of an oil spill and the attendant cost of cleaning the generator area;

FIG. 7 shows a still further alternative embodiment of the invention showing the utilization of multiple reserve oil tanks;

FIG. 8 shows a still further alternate embodiment of the present invention with the addition of data storage and communications equipment allowing the unit to monitor system conditions that could affect oil life, notify central service offices of the need for an oil change and record and transmit the results of completed oil changes;

FIG. 9 shows a block diagram of a communications network between a central office and a plurality of cogeneration systems;

FIG. 10 shows a still further alternative embodiment of the invention utilizing an oil warming feature with a single oil reserve tank;

FIG. 11 shows a still further alternative embodiment of the invention utilizing an oil warming feature with a multiple reserve oil tanks; and

FIG. 12 shows a still further alternative embodiment of the invention disclosing a different adapter configuration.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated. It should be further understood that the title of this section of this specification, namely, “Detailed Description Of The Invention”, relates to a requirement of the United States Patent Office, and does not imply, nor should be inferred to limit the subject matter disclosed herein.

In the present disclosure, the words “a” or “an” are to be taken to include both the singular and the plural. Conversely, any reference to plural items shall, where appropriate, include the singular.

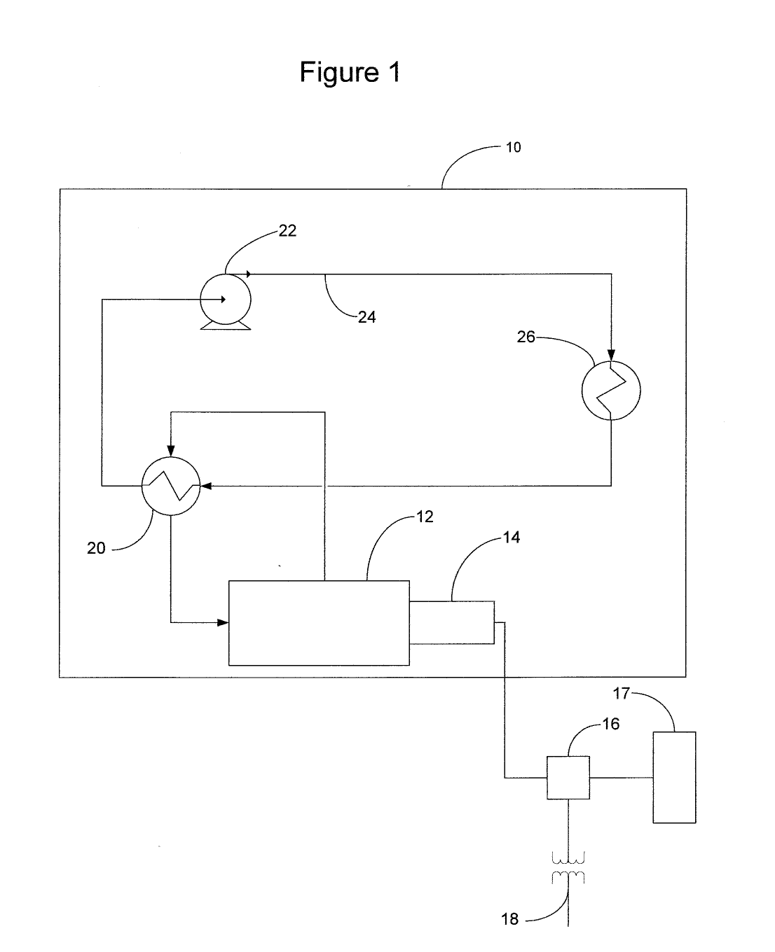

Referring to FIG. 1, a block diagram representing a reciprocating engine driving CHP cogeneration system 10 is shown. The CHP system 10 includes a reciprocating engine 12 that is operatively coupled to a generator 14. The generator supplies electricity to the host site through electrical switchgear 16 which allows the CHP system to supply the host site with up to 100% of its electrical loads 17 and/or to the utility grid 18 as proscribed by local utility regulations. The CHP system 10 also and simultaneously utilizes an engine heat recovery heat exchanger 20 and thermal loop circulating pump 22 to transfer heat via a thermal heating loop 24 to be used for various heating loads 26 such as water heating, space heating, chilling or other heating needs.

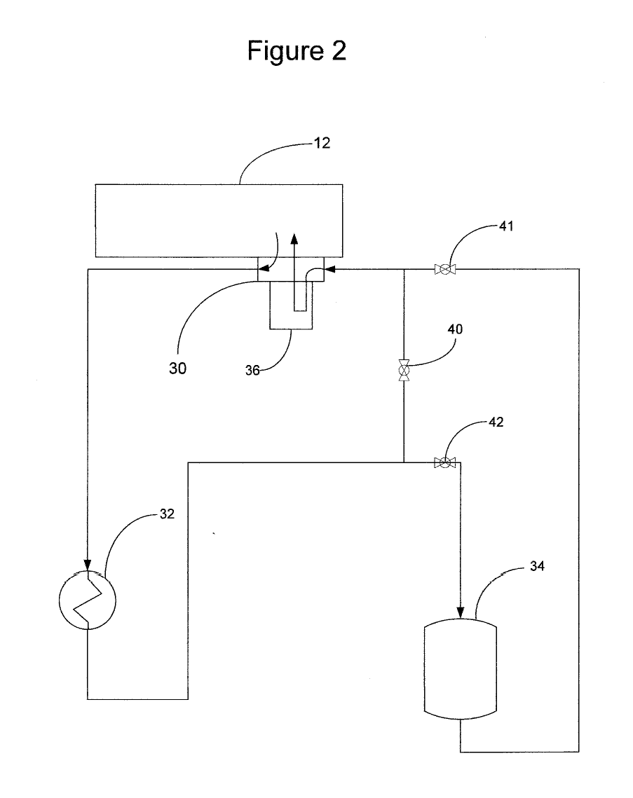

FIG. 2 shows the oil system configuration of the engine 12 shown in FIG. 1 that allows for the changing of oil without the necessity of turning the engine off during servicing. The system allows for the changing of a sufficient majority of the engine oil without the necessity of turning the engine off during oil servicing. This configuration includes an oil tank 34, and oil tank bypass valve 40 with oil tank isolation valves 41 & 42. This configuration allows a user to open the bypass valve 40 and to close the oil tank isolation valves 41 & 42 so that a small portion of the engine oil can circulate through the remote oil cooler adapter 30, the oil cooler 32 and oil filter 36 while isolating the majority of the oil in a separate circuit. This action allows the engine to remain in operation while the majority of the oil is drained and replaced.

After replacing the isolated oil, reversing the operation of the oil tank isolation valves 41 & 42 and the bypass valve 40 allows the full volume of the new clean oil to circulate through the engine oil system. Oil tank 34 is a device of any shape and construction that adds oil volume to the engine system in an amount appropriate for the application. Oil flows through it as an integral part of the engine oil system so all of the original volume plus the tank volume is in circulation. The larger volume is a method to extend the oil life. It does this because the larger volume is less sensitive to the addition of dirt and wear.

During operation, the engine will naturally create a fixed amount of dirt in a fixed amount of time and a fixed amount of oil will break down or “wear out” in that same time. As dirt builds up in the oil and oil breaks down, the oil loses effectiveness. Additionally, the more dirt there is in any given amount of oil the more the engine will wear. Essentially it's a self-perpetuating circle. In practical terms, dirt, impurities and oil breakdown are measured as a relationship to the oil volume, parts per million as an example. Since the engine creates a fixed amount of dirt in any given time, increasing the oil volume decreases the relative impurities in the oil. By way of example, doubling the oil volume cuts the impurities in the oil by half; tripling the volume cuts the impurities by two thirds.

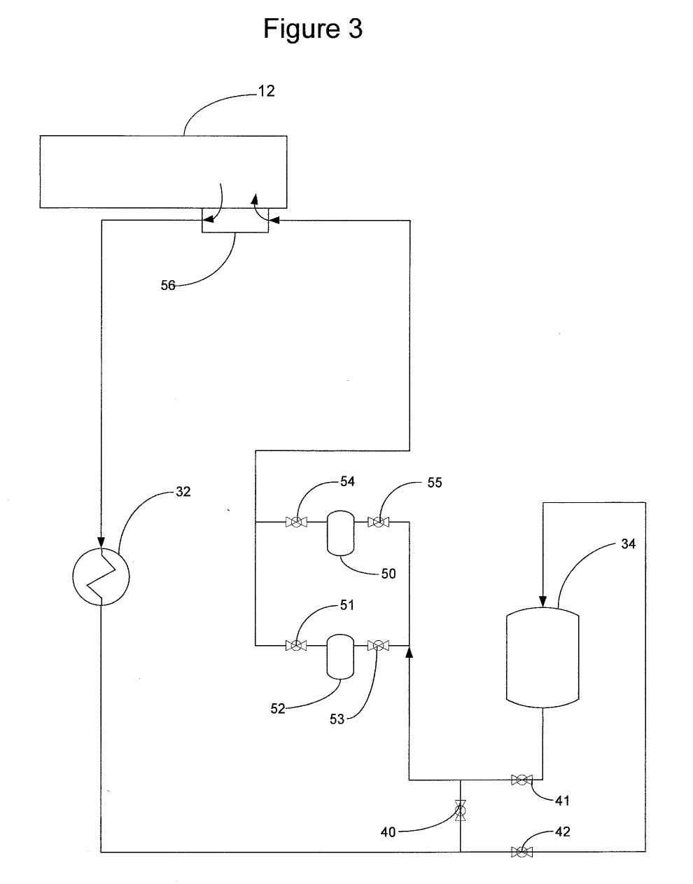

FIG. 3 shows the revised oil system configuration with the addition of multiple oil filters that can be individually isolated and changed without effecting the operation of the engine 12. This embodiment includes a remote oil filter adapter 56 and two oil filters 50 & 52 that can be individually isolated using oil filter isolation valves 51, 53, 54 & 55 without interrupting the operation of the engine. This configuration allows for the oil and oil filters to be changed without affecting the operation of the engine or leaving the engine unprotected by an oil filter during an oil change. For example, by leaving valves 51 and 53 open and closing valves 54 and 55, filter 52 can be used to allow the engine 12 to continue running while filter 50 is replaced. After filter 50 is replaced, reversing the procedure by opening valves 53 and 54 will put the new clean filter into service. This procedure can be then be repeated for filter 52 by closing valves 51 and 53, replacing filter 52 and re-opening valves 51 and 53 giving the system two clean filters in operation.

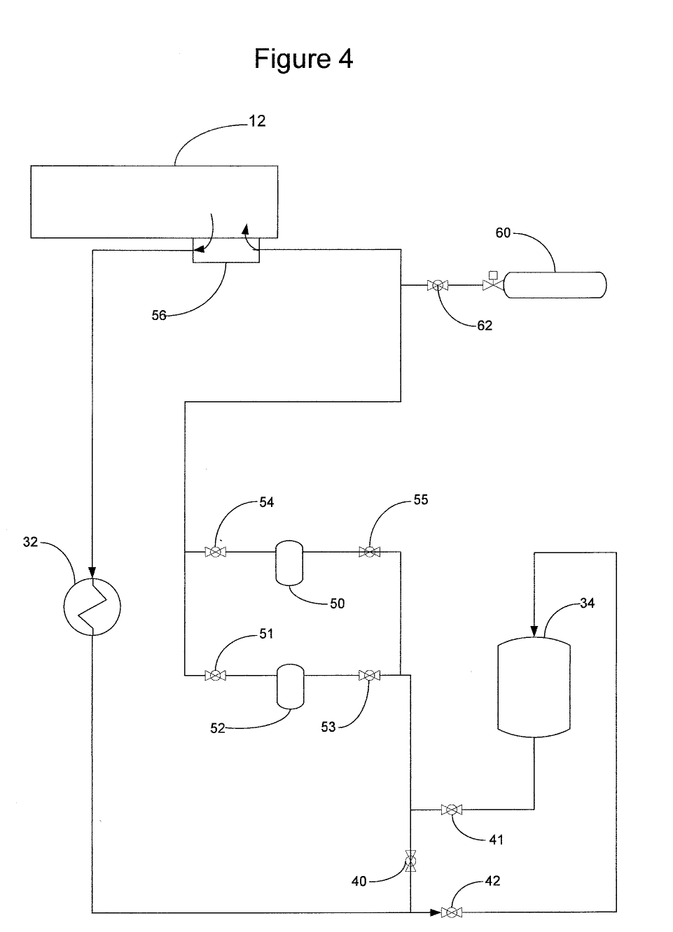

Referring to FIG. 4, a block diagram showing a further embodiment of the current invention is shown which includes an oil pressure accumulator assembly 60 with accumulator isolation valve 62. This further embodiment can minimize oil pressure fluctuations associated with improper valve assembly operation. During normal operation the oil pressure accumulator is filled with oil under pressure by the engine oil system. If during any part of the oil changing procedure the oil pressure in the system drops below a pre-set point, the oil pressure accumulator 60 will release the oil that is stored at sufficient pressure to compensate for any short term oil pressure drops associated with the improper operation of the valve assemblies. The accumulator isolation valve 62 can be used to isolate the accumulator assembly 60 when the accumulator assembly needs to be inspected or repaired.

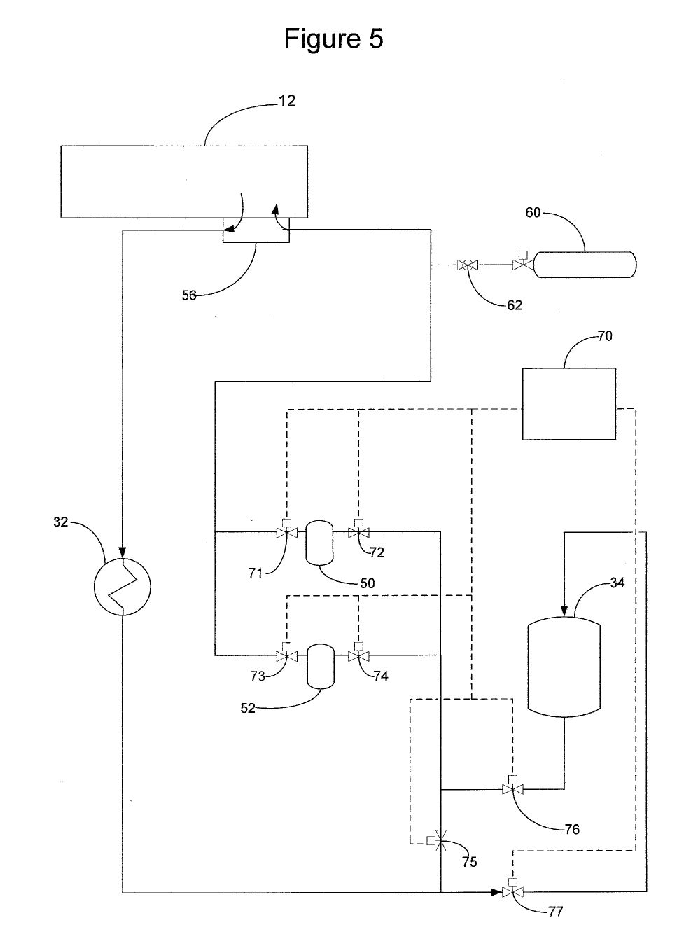

FIG. 5 shows an alternate construction for the FIG. 4 embodiment with the addition of electronically actuated valves which allows for automation and consistent application of the oil changing process. Electronically actuated valves 71, 72, 73, 74, 75, 76 & 77 are used in place of the previously manually actuated valves and are controlled by a PLC and/or other automation controls 70. By way of example, a service technician will access the PLC 70 to initiate an oil change by pressing a start button. The PLC will open the oil bypass valve 75 and close the oil tank isolation valves 76 and 77. When this is complete the PLC will indicate it is safe to empty and replace the oil. When the used oil in tank 34 is emptied and replaced with clean oil the service technician will press an Oil Change Complete button and the PLC will open the oil tank isolation valves 76 & 77 and close the oil bypass valve 75 to allow the full volume of the new clean oil to circulate in the engine oil system. If the oil filters must be replaced the technician will press the appropriate Change Oil Filter button. For example, to change oil filter 50 the technician would press the Change Oil Filter button associated with oil filter 50 and the PLC will close valves 71 and 72 and indicate that oil filter 50 is ready to be changed. When the filter is changed the technician will press the Oil Filter Change Complete button and the PLC will open valves 71 and 72 to put the new clean filter into service.

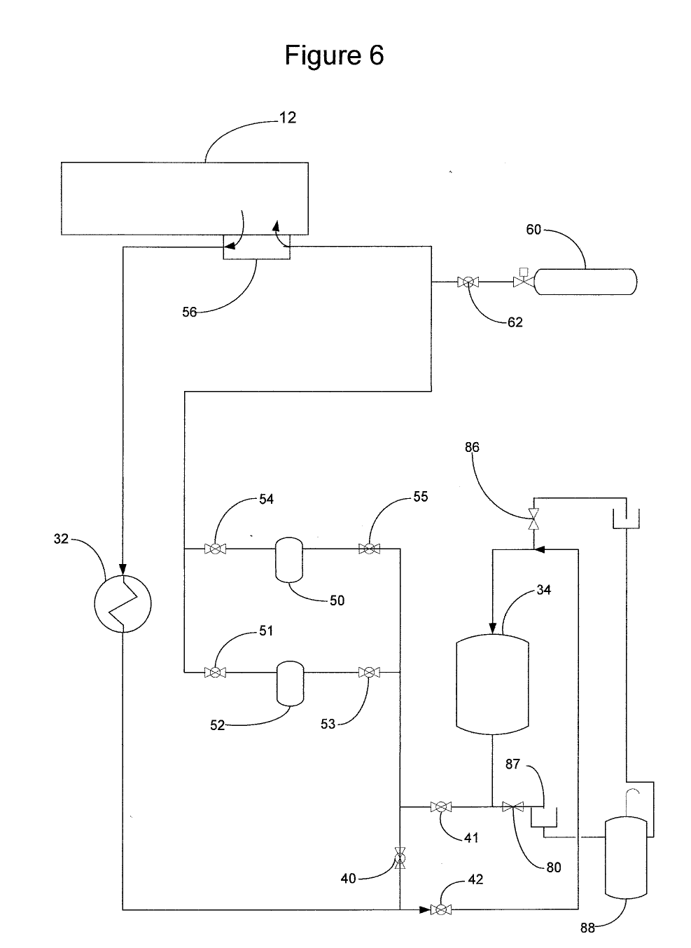

FIG. 6 is a block diagram showing a further embodiment of an oil system incorporating a single point of connection to facilitate automated oil changes and faster manual oil changes while reducing the risk of an oil spill and attendant associated costs. This embodiment includes a system low point drain valve 80, a connection to oil transfer pump 87, drains to a containment tank 88 and a high point vent 86 for draining and filling the oil for the system. With the addition of these components, the appropriate valves can be operated to isolate different areas of the oil system for complete oil evacuation and refilling within a completely closed system.

As an example, to change the oil with this embodiment, a service technician would attach a transfer pump to connection 87, open oil bypass valve 40 and close oil tank isolation valves 41 and 42 to isolate the majority of the oil in the oil tank 34 portion of the oil system. The technician would then open the high point vent 86 and engage the transfer pump to empty the oil system. When the oil is completely drained, the transfer pump would be used to refill the system. When the system oil has been replenished, the technician will close the high point vent 86, open oil tank isolation valves 41 & 42 and close the bypass valve 40, to allow the full volume of the new clean oil to circulate through the engine oil system. The drains at points 86 and 87 and containment tank 88 are used to catch and contain any oil that is accidently spilled during connection and refilling.

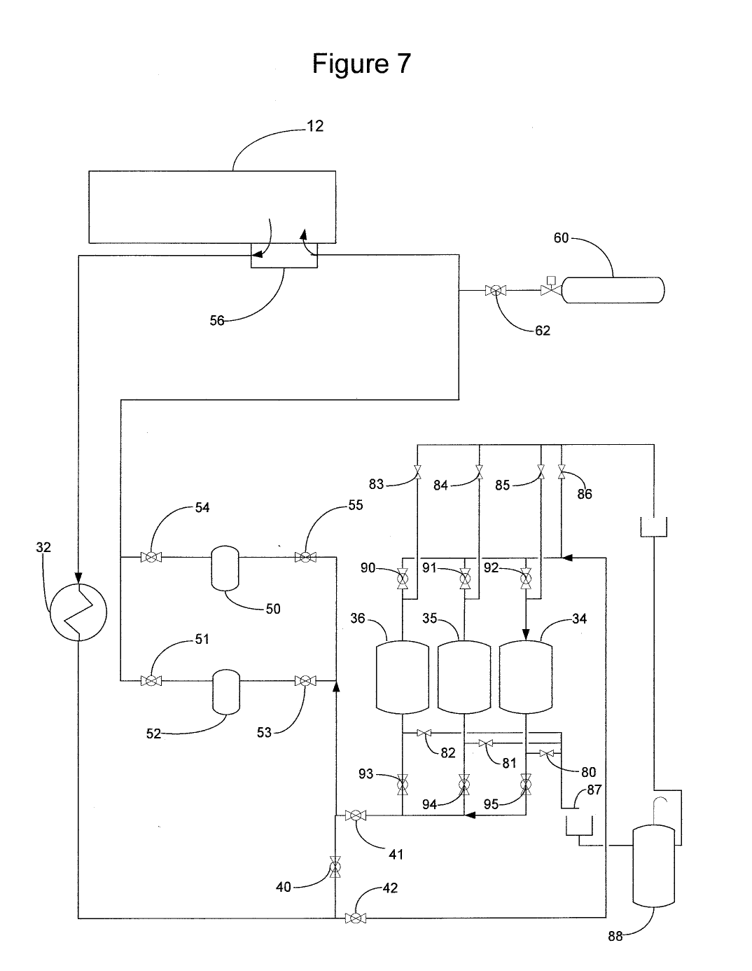

FIG. 7 is a block diagram representing a further embodiment of present invention with the addition of multiple oil reservoirs 34, 35 & 36, reservoir isolation valves 90, 91, 92, 93, 94 & 95 and reservoir high point vent valves 83, 84 & 85. Multiple reservoir drain valves 81 & 82 are also included. This configuration allows for the filling of multiple separate reservoir systems to facilitate faster oil changes over extended durations. By operating the appropriate reservoir isolation valves 90, 91, 92, 93, 94 & 95, individual oil reservoirs can be placed into service or removed from service. This method allows for the tanks to be evacuated and refilled at alternating service calls while the interim service calls are needed simply to change the tanks. This enhances the operation by reducing the service time needed for 50% or more of the scheduled service calls.

By way of example in a system supplied with two oil reservoir tanks 34 & 35, a service technician would perform an oil change as described in previous embodiments above leaving isolation valves 92 and 95 open to put oil tank 34 into service and leaving tank isolation valves 91 and 94 closed isolating oil reservoir tank 35 from service. The technician will also leave valves 51 and 53 closed with a new clean filter 52 in place. This leaves a sufficient amount of clean oil and a clean oil filter available to quickly perform an oil change at a later date without the necessity to drain, replace or transport any oil. When the next service is due, a technician would open the oil bypass valve 40 and close oil tank isolation valves 41 and 42 to isolate the oil in the tank systems from the engine. With the oil tank system out of operation, the technician would close isolation valves 92 and 95 taking tank 34 out of service. The technician would then open isolation valves 91 and 94 to ready oil tank 35 for service. Opening oil tank isolation valves 41 & 42 and closing oil bypass valve 40 will bring the new clean oil in tank 35 into service. If appropriate, the technician can also open valves 51 and 53 to bring the new clean filter 52 into service and close valves 54 and 55 to take the old dirty oil filter 50 out of service.

By operating the system in this manner, the process of emptying and filling the oil tanks will only be extended by a very short amount of time, but any subsequent oil changes performed by simply bringing reservoir tanks into and out of service via the valve assemblies will be reduced by many hours. The reduction in hours will significantly lower the high costs associated with the hourly rate of highly trained service technicians. Further cost reduction will be created during interim service calls because the need to transfer, transport and store oil will be eliminated.

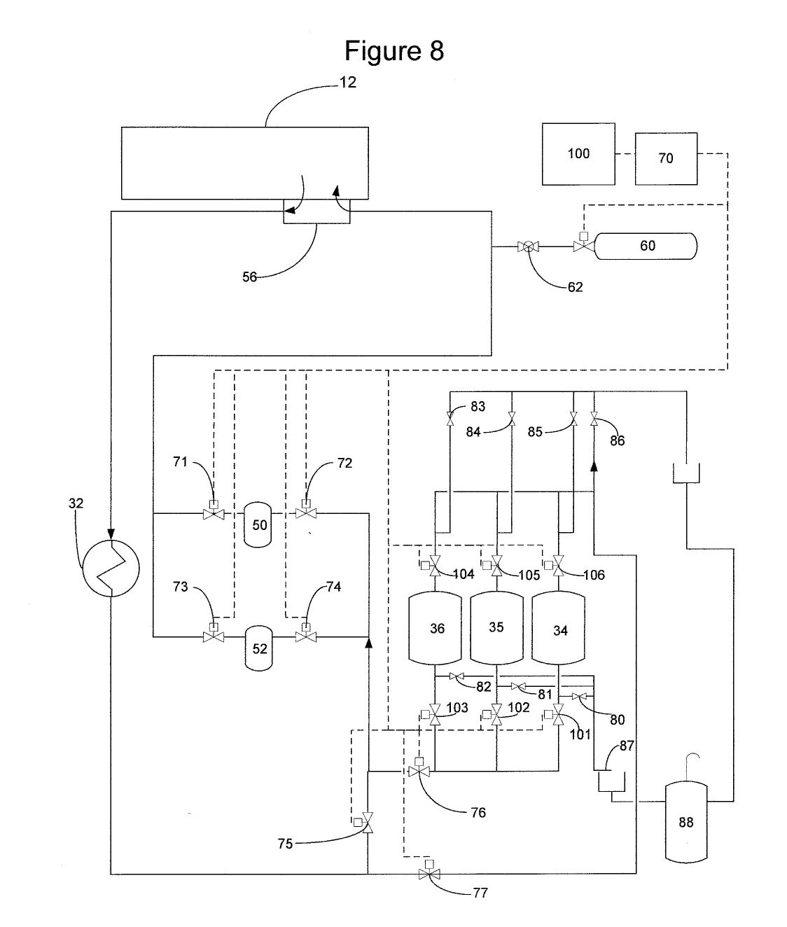

FIG. 8 is a block diagram showing a further embodiment of the present invention with the inclusion of data storage and communications equipment 100. It also includes additional automated oil tank bypass valves 75, remotely actuated oil reservoir system isolation valves 76 & 77 and remotely actuated oil reservoir isolation valves 101, 102, 103, 104, 105 & 106. These additions allow for the monitoring of system conditions, notification of central service offices of the need for an oil change, actuate system components to effect various system functions such as changing from one oil reservoir system to another or changing which filter is in service, and/or record and transmit the results of completed oil changes. The data storage and communications equipment 100 may include a processor and a memory. Computer executable instructions may be stored in the memory that, when executed by the processor, cause the data storage and communication equipment 100 to monitor system conditions, transmit information regarding system conditions to computers operating at a central service office, and receive instructions from such computers. The received instructions may cause the processor to actuate the system components to undertake an oil change, change from one oil reservoir to another, select an oil filter to put into service, and the like.

By way of example, this embodiment further enhances the advantages of the embodiment described in FIG. 7 by allowing operators to remotely control oil changes involving bringing oil reservoirs in and out of service. This feature further and significantly reduces cost by eliminating the need for a service technician to travel to and physically work on the equipment in any capacity during these types of operation. This will have an especially profound impact on users or service groups that operate multiple systems over a diverse geographic territory as a single operator at a central service center can monitor and perform many oil changes without visiting a machine location.

The present invention provides numerous advantages. For example, when cogeneration system 10 is not operating during a service operation, the back-up generation protection of the unit during a power failure is lost. The typical configuration of a cogeneration system allows the unit to provide power in parallel with the electric utility grid for a substantial amount of a user's electrical load. During start-up, the load on the generator must be brought on line gradually and in a controlled manner. It can take several minutes for a cogeneration unit to be brought to its full capacity and the technology requires that the utility grid be present and supplying power to the site as the loads are transferred to the cogeneration system. If electrical loads are applied to the cogeneration equipment too quickly, overload circuits will trip taking the cogeneration equipment out of service. Once the loads have been successfully transferred to the cogeneration unit, the system can control varying loads and the system can act as a back-up generator if a utility outage occurs.

While the control and overload breaker protection do not pose any operational issues during normal circumstances, a cogeneration unit cannot be started during a utility outage. Because of this the back-up power potential of the system is completely negated if a power failure occurs during a service operation as the system cannot be returned to service until power from the utility is restored. In some cases, cogeneration equipment is designed with features to allow the unit to be placed into service without a utility presence. In some embodiments, cogeneration equipment may be designed with features, typically knows as “Black Start” capability, that allow the unit to be placed into service without a utility presence.

All of the foregoing description of the present invention concerns a stand-alone cogeneration system. However, it will be appreciated to those of ordinary skill in the relevant art that the techniques underlying the present invention can be implemented in a kit form to allow existing reciprocating engine based cogeneration systems to be retrofitted to include the above-described oil and oil filter change features.

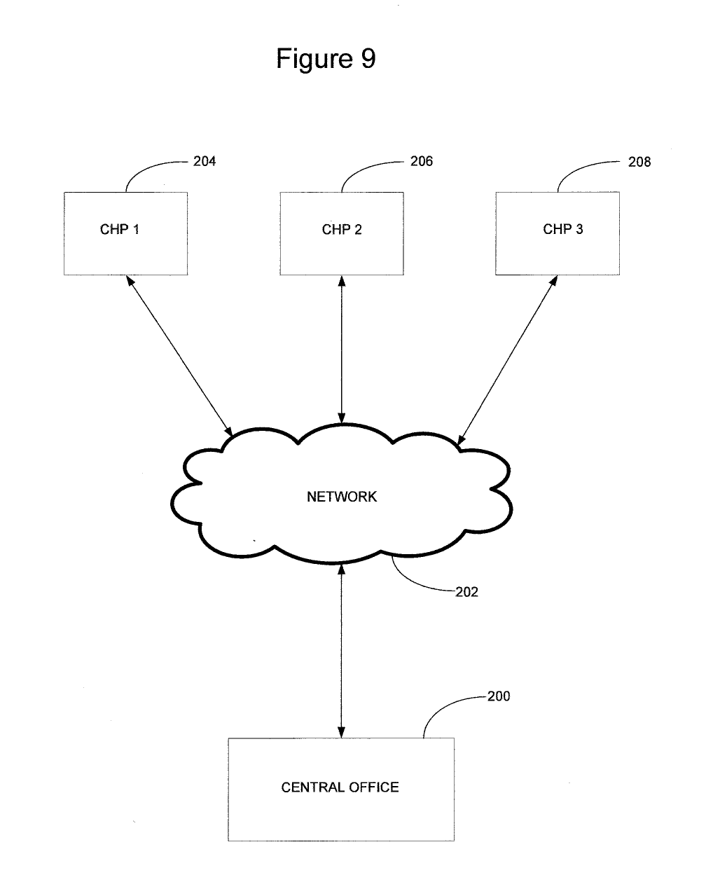

Referring to FIG. 9, a block diagram is shown of a communications network between a central office 200 that communicates with a plurality of different cogeneration systems over a network 202. In the illustrated embodiment, three cogeneration systems 204, 206 and 208 are shown, each of which includes appropriate hardware to allow messages to be sent through network 202 to the central office 200. As an example, the network 202 could be the PSTN, a cellular phone network, or a radio network. The central office 200 includes suitable programming and processing power for it to keep track of the maintenance states of each cogeneration system 204, 206 and 208 so as to be able to maximize the labor savings arising from, for example, the scheduling of maintenance calls to specific systems. As described hereinabove, the central office 200 may have one or more computers that include a processor and memory coupled thereto. Computer executable instructions may be stored in the memory that, when executed, cause the computer to receive system status from one or more cogeneration systems 204, 206, and 208, determine if an oil change or other action is necessary at such system, and generate instructions that are transmitted to the data storage and communication equipment at one or more of the cogeneration systems 204, 206, and 208. The transmitted instructions may direct the data storage and communication equipment at one or more of the cogeneration systems 204, 206, and 208 to undertake system operations as described hereinabove.

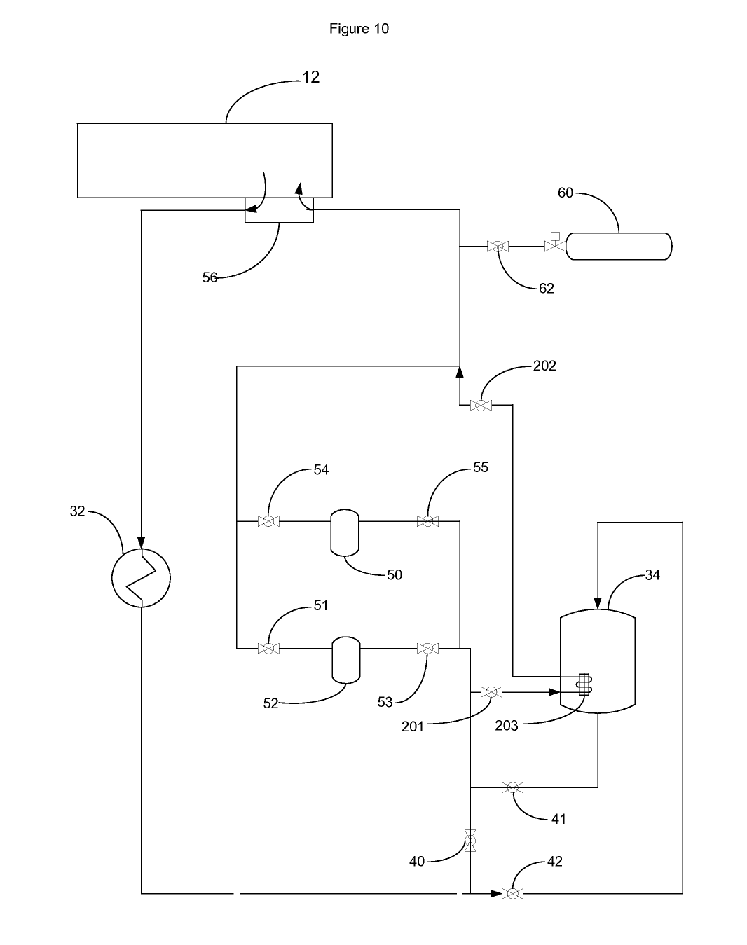

FIG. 10 is a block diagram representing a further embodiment of present invention with the addition of valves 201 and heat exchange coils 203. By operating valve 203 a portion of some or all of the oil circulating through the engine can be diverted to flow through additional oil lines and heat exchange coils that are placed inside the oil reservoirs 34. By flowing oil through the oil lines and heat exchanger coils the oil in the reservoirs will be heated above the ambient temperature. During operation oil that is in use will circulate through the heat exchanger keeping the stored oil at or near the correct operating temperature and ready for deployment when desired. Because the oil continues to flow through a closed system, valve 203 can be left open and oil can be diverted through the warming mechanism whether the reservoir is in use or not.

By way of example, during normal operation the engine oil in a reciprocating engine is heated. While all engines are different, the range of normal operating temperatures for engine oil is above 100 degrees centigrade and below 130 degrees centigrade (212-270 degrees Fahrenheit). In normal operation, the oil change invention will introduce new, clean oil at whatever the ambient temperature is of the operating environment. In all cases, this will cause the temperature of the new, fresh oil to be well below the temperature of the existing oil that is being replaced. In addition and because of the lower temperature, the viscosity of the new, fresh oil will be higher than that of existing warm oil. In some cases, a sudden change of temperature and viscosity in the operating engine could be harmful to the engine. This could be especially true when the ambient temperature the unit is operating in is extremely cold.

By operating the valves of the current invention in a controlled manner during the introduction of the new, fresh oil into the system, the new oil can be introduced into the engine slowly allowing the new oil to be heated and match that of the existing oil thus mitigating any issues with this aspect of the oil change.

Thus, it is highly desirable to easily warm the new, fresh oil to the correct operating temperature prior to introducing it into the engine during an oil service.

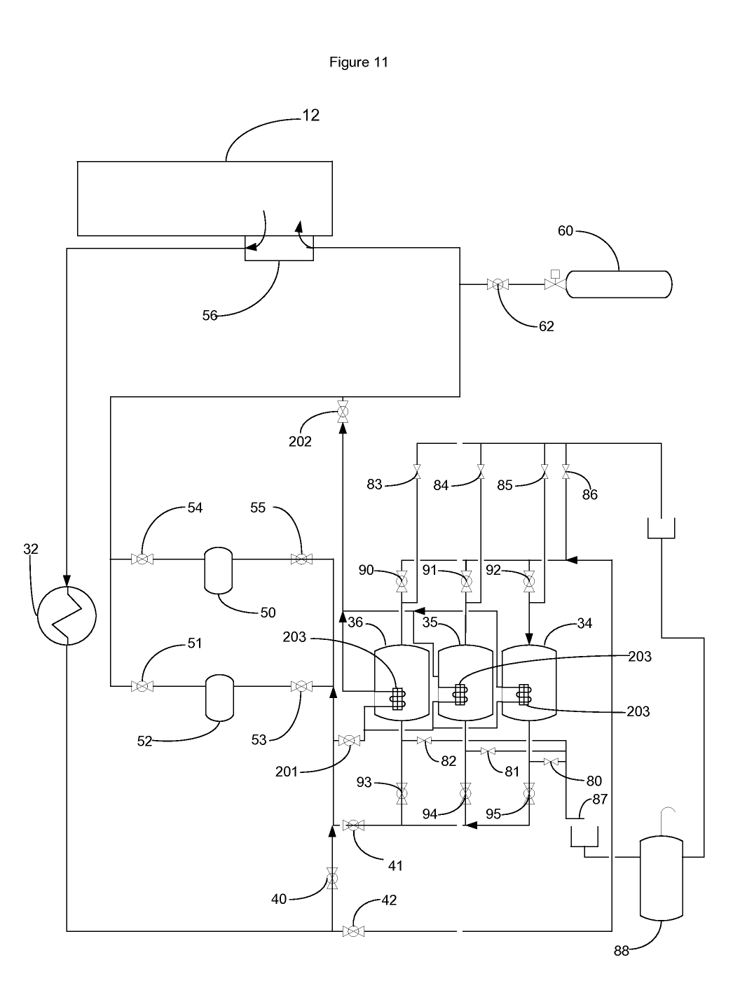

FIG. 11 is a block diagram representing a further embodiment of present invention with the addition of multiple oil reservoirs with the addition of valves 201 and heat exchange coils 203. By operating valve 203 a portion of some or all of the oil circulating through the engine can be diverted to flow through additional oil lines and heat exchange coils that are placed inside the individual oil reservoirs 34, 35 & 36. By flowing oil through the oil lines and heat exchanger coils the oil in the reservoirs will be heated above the ambient temperature. During operation oil that is in use will circulate through the heat exchanger keeping the stored oil at or near the correct operating temperature and ready for deployment when desired. Because the oil continues to flow through a closed system valve 203 can be left open and oil can be diverted through the warming mechanism whether there reservoir is in use or not.

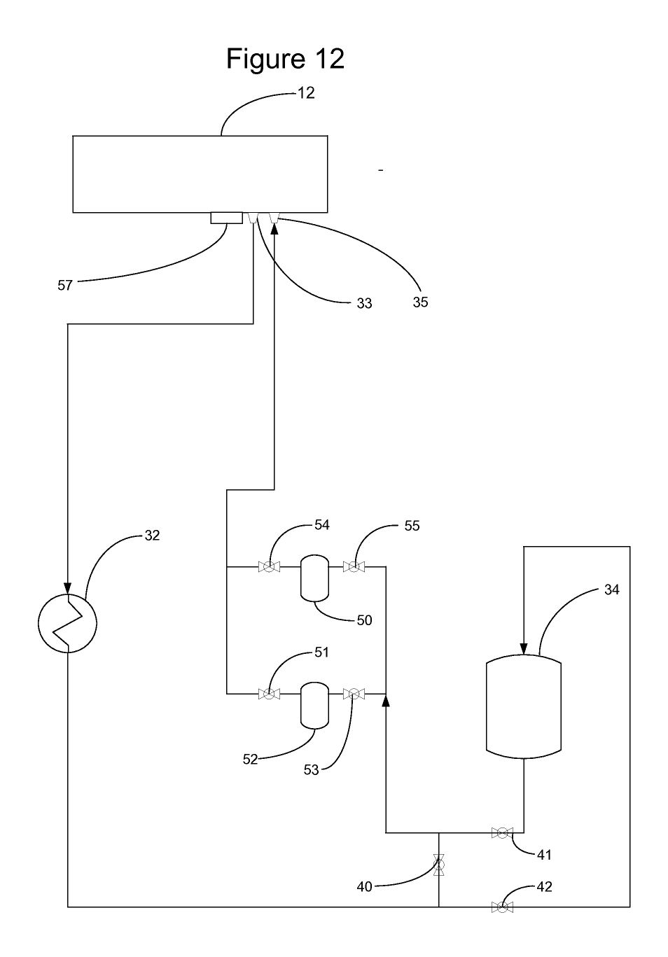

FIG. 12 is a block diagram representing a further embodiment of the invention utilizing factory installed oil cooler/remote oil filter connections 33 & 35 rather than the previously referenced remote oil cooler adapter 30. By way of example, engine manufacturers have the option of adding a feature to their engines that allow for the direct attachment of a remote oil cooler and/or a remote oil filter. Utilizing this feature, if available, eliminates the need to attach the previously referenced remote oil cooler adapter 30 to utilize the invention. When incorporating attachment points for a remote oil cooler and/or remote oil filter in their engine design, manufacturers have the further option of including or eliminating an attachment point for an oil filter. If a particular engine has both attachment points for a remote oil cooler and/or remote oil filter and attachment points for an oil filter, an oil filter blanking device 57 will be installed.

The cogeneration systems of the present invention may use reciprocating engines driven by a various fuels including diesel, gasoline, or natural gas. Furthermore, changing oil and/or oil filters of such engines does not require any additional lubricant to be intentionally directed into the fuel for combustion purposes.

The systems described hereinabove may be used to replace a majority of the dirty oil of an engine to with clean oil.

U.S. Pat. Nos. 5,390,762 and 5,720,249 disclose an automatic crankcase oil change and an apparatus for burning spent lubricant in an internal combustion engine. Both patents are incorporated by reference into this application as if fully set forth herein. The technology covered by these patents is sold for use in diesel engines (although the patent refers to gasoline engines as well). It works by mixing a small amount of oil in with the diesel fuel. The oil is then consumed in the normal diesel process. The technology takes advantage of the fact that diesel fuel is far less refined than gasoline and is closer to oil than conventional motor fuel. Because the diesel is basically burning oil as it goes along, the small amount of dirty oil mixed into the process every once in a while does not affect the performance of the engine.

With the addition of an oil supplementing system to replace the dirty oil that is removed from the crankcase, the patented technology effectively gets rid of the dirty oil in the crankcase. This only works in an engine that burns oil (diesel fuel) to begin with. The technology will not work well in an engine that burns gasoline, nor will it work in an engine that burns natural gas. While all engines consume some oil, purposely introducing “extra” dirty oil into the combustion chamber during operation will at best, hinder the performance. It is more likely that the process would damage the engine and almost certainly destroy the pollution control systems and catalytic converters.

Utilization of one or more aspects of the technology involved with the present invention avoids these problems for a number of different reasons. For example, the present invention involves the utilization of gasoline or natural gas driven reciprocating engines in which no lubricant is intentionally directed into the fuel for combustion purposes as is required by the above-noted patents.

As an additional example, the prior art patents do not allow for a majority of the dirty oil of an engine to be replaced with clean oil. A stationary engine that runs 24/7 holds more than 6 gallons of oil at a minimum. With a service cycle of 30-60 days, the device would have to feed more than a quart of oil a day through the engine to consume the volume of oil that resides in the engine. Assuming for a moment that an engine could consume that volume of oil, the system would be adding small amounts of clean oil into to a reservoir filled with 24 quarts of dirty oil, a ratio that wouldn't be very effective for keeping the oil clean. Performing oil cleaning by consuming small amounts of dirty oil and replacing it with clean oil simply is irrelevant to the technology disclosed and claimed in this application. Moreover, when a natural gas engine is used, it is not possible to use the technology of the prior art patents because, for example, natural gas is not a liquid with which the oil could mix, which means that the system would be injecting raw, undiluted dirty oil into the combustion chamber. That simply will not work.

One aspect of the present invention is that it becomes an integral part of the engine oil system. No additional or auxiliary pumps are necessary nor does it require modification to, or additional loading of, other ancillary systems which are not normally associated with the function of circulating engine oil. The present invention can completely isolate any and/or all of the oil tanks from engine oil system while allowing for continued operation of the engine which mitigates the risk of cross contamination between tanks during an oil change.

U.S. Pat. No. 7,686,136 is an example of a prior art system that requires and necessitates careful manipulation and monitoring of the valves to avoid mixing of oil between oil multiple containers. This patent is incorporated by reference into this application as if fully set forth herein. This patent arguably relates to the changing of oil in an engine by transferring oil between the engine and alternate tanks using auxiliary or supplemental pumps. However, in order to facilitate and control the transfer of oil, the system requires modifications to, and additional loads being placed upon, the engine vacuum system and controls. These vacuum systems and controls are specifically designed by the manufacturer to be used for critical functions such as engine control, emission controls and braking systems. They are not designed to anticipate, nor are they equipped for additional loads added by aftermarket products.

In one embodiment of the present invention, a cogeneration system comprises a generator that is adapted to be operatively coupled to switchgear so that, when the generator is connected to the switchgear, electricity can be supplied to one or more loads or to a power grid; a reciprocating engine that is adapted to be operatively coupled to the generator to allow the generator to generate electricity; an adapter coupled to engine to create an oil flow path out of the engine, through an oil cooler, through an oil tank and then back to the reciprocating engine; and a first valve assembly positioned in the oil flow path that is moveable from an open to a closed position, wherein, when the first valve assembly is disposed in the open position, oil flows in the oil flow path out of the engine, through both the oil cooler and the oil tank, and then back to the reciprocating engine, and wherein, when the first valve assembly is disposed in the closed position, oil flows in the oil flow path out of the engine, through the oil cooler and then back to the reciprocating engine without flowing through the oil tank thereby allowing the oil tank to be removed and any oil contained therein to be replaced with new oil without turning off the reciprocating engine. The adapter can be integrally formed as a portion of the engine or, as typically would be the case, is removably coupleable to the reciprocating engine. The adapter also can include an oil filter that allows engine oil to be filtered immediately prior to being returned to the reciprocating engine.

One aspect of the present invention concerns an engine oil filter change feature comprising two or more oil filters that are connected in parallel in the oil flow path, together with an appropriate valve assembly that prevents oil from flowing through one of the filters while allowing oil to flow through the other filter(s) to allow the filter through which oil flow is prevented to be replaced without requiring that the reciprocating engine be turned off.

A further aspect of the invention concerns the utilization of an oil pressure accumulator in a cogeneration system that is operatively coupled in the oil flow path so that, if the pressure in the oil flow path drops below a predetermined threshold, then additional oil under pressure can be provided in the oil flow path.

A still further aspect of the present invention concerns the connection of an oil transfer pump in the oil flow path to allow dirty oil to be drained from the oil tank of a reciprocating engine of a cogeneration system and then replaced with clean oil without requiring that the engine be turned off.

One aspect of the present invention concerns the utilization of sufficient computing power in a cogeneration system (e.g., a programmable logic controller with a display screen and suitable operator input keys) that allows status information regarding the oil and filter change features in use at a particular cogeneration system to be transmitted over a communications network (e.g., PSTN, a cellular network or a radio network) to a central monitoring authority. By doing so, the central authority is better able to manage the scheduling of oil changes so that labor costs associated with maintaining a fleet of cogeneration systems can be minimized.

In the preceding description of the various embodiments of the present invention, the illustrated equipment providing the oil and filter change features is shown downstream of the oil cooler in the oil flow path to and from the reciprocating engine. This is done for two principal reasons. First, the oil cooler is one of the places where heat is taken from the system for transfer or sale to the customer. In order to get the most heat for sale, it is advantageous to get the hottest oil possible which is directly from the engine. If the filters were installed ahead of the oil cooler some of the heat we could sell would be lost in that portion of the oil loop. Second, in order to protect the engine in the most complete fashion, the filters should be the last thing the oil goes through prior to returning to the engine. However, it should be appreciated that it is within the scope of the present invention that such equipment could be upstream from the oil cooler even though doing so would result in a less efficient cogeneration system.

In the preceding description of the various embodiments of the present invention, the illustrated tanks show the oil flowing into the tank from the top and being drawn out from the bottom. This is to reduce or eliminate the effects of the air build up the oil circulating system. If any air gets into the system, which happens from time to time for various reasons, such as when small bubbles get trapped in the oil stream, the air will rise to and collect at the top of the tank. At some point a large bubble could form at the top and that would either be drawn into the oil system, or worse, stop the oil from circulating completely.

While the present invention is shown in the context of a complete reciprocating engine driven cogeneration machine, it should be understood that aspects of the present invention allow for it to be retrofitted to an existing cogeneration system or other stationary engine applications.

What is claimed is:

1. A cogeneration system, comprising:
a generator that is adapted to be operatively coupled to a switchgear so that, when the generator is connected to the switchgear, electricity can be supplied to one or more loads or to a power grid;
a reciprocating engine that is adapted to be operatively coupled to the generator to allow the generator to generate electricity;
an adapter coupled to said engine to create an oil flow path out of the engine, through an oil cooler, through an oil tank and then back to the reciprocating engine; and
a first valve assembly positioned in the oil flow path that is moveable from an open to a closed position, wherein, when the first valve assembly is disposed in the open position, oil flows in the oil flow path out of the engine, through both the oil cooler and the oil tank, and then back to the reciprocating engine, and wherein, when the first valve assembly is disposed in the closed position, oil flows in the oil flow path out of the engine, through the oil cooler and then back to the reciprocating engine without flowing through the oil tank thereby allowing the oil tank to be removed and any oil contained therein to be replaced with new oil without turning off the reciprocating engine.

2. The cogeneration system of claim 1, wherein the adapter is removably coupleable to the reciprocating engine.

3. The cogeneration system of claim 1, wherein the adapter further includes an oil filter that allows engine oil to be filtered immediately prior to being returned to the reciprocating engine.

4. The cogeneration system of claim 1, further comprising
first and second oil filters that are disposed in parallel in the oil flow path, as well as second and third valve assemblies both of which are movable between open and closed positions, and
wherein, when the second valve assembly is open and the third valve assembly is closed, oil can flow throw the first oil filter but not the second oil filter thereby allowing the first oil filter to be removed and changed without requiring that the reciprocating engine be turned off.

5. The cogeneration system of claim 1, further comprising an oil pressure accumulator that is operatively coupled in the oil flow path so that, if the pressure in the oil flow path drops below a predetermined threshold, then additional oil under pressure can be provided in the oil flow path.

6. The cogeneration system of claim 1, further comprising a fourth valve assembly that allows an oil transfer pump to be connected in the oil flow path to drain dirty oil from the oil tank and to replace it with clean oil.

7. The cogeneration system of claim 1, wherein the adapter comprises a single unit.

8. The cogeneration system of claim 1, wherein the adapter comprises two or more separate units.
